(19) United States
(12) Patent Application Publication
(10) Pub. No.: US 2015/0269667 A1
(43) Pub. Date: Sep. 24, 2015

(54) METHOD AND SYSTEM FOR CONSUMER BEHAVIOR MODELING BASED ON INSTALLMENT PAYMENTS

(71) Applicant: MasterCard International Incorporated, Purchase, NY (US)

(72) Inventor: David GROSSMAN, Brooklyn, NY (US)

(73) Assignee: MasterCard International Incorporated, Purchase, NY (US)

(21) Appl. No.: 14/219,215

(22) Filed: Mar. 19, 2014

(51) Int. Cl. G06Q 40/02

(52) U.S. Cl. CPC G06Q 40/025

(57) ABSTRACT

A method for predicting consumer behavior includes: storing a plurality of consumer profiles, wherein each consumer profile includes data related to one or more consumers including at least consumer data and a profile identifier; receiving, by a receiving device, an authorization request or clearing record for a payment transaction, wherein the authorization request or clearing record includes at least an indication of the payment transaction as an installment transaction, transaction data, a specific profile identifier, a repayment length, and an installment amount; identifying a specific consumer profile where the included profile identifier corresponds to the specific profile identifier; and transmitting, by a transmitting device, an indication of a propensity to have available funding based on the repayment length, wherein the indication includes at least the consumer data included in the identified specific consumer profile and the installment amount included in the received authorization request or clearing record.

### FIELD

The present disclosure relates to the modeling of consumer behavior based on installment payments, specifically the predicting of available consumer funding based on installments entered into by a consumer.

### BACKGROUND

In many economic markets, installment payments may often be used to encourage consumers to make purchases on big ticket products while deferring costs to a recurring payment. Such arrangements can enable consumers to purchase items that they otherwise would be unable to afford or save up money for, and to receive such items at the start of the recurring payment. In addition, the knowledge of the recurring payments and their schedules can assist consumers with managing personal cash flow and expenses.

Once a consumer has finished paying off a product via installment payments, the consumer may have an increase in available funding by virtue of money that the consumer had previously allocated to the installment payment. The increase in available funding may have an effect on the consumer's purchase behavior, financial risk, credit, purchasing power, or other metric. Analysis of such metrics may be beneficial in the providing of additional services to the consumer, such as by updating of the consumer's credit score and financial risk, which may leave the consumer in a more advantageous financial position. But doing so present technological problems in accurately determining when a consumer has finish paying off an installment purchase without requiring the consumer's or merchant's involvement.

Thus, the present inventor believes there is a need for a technical solution to predict changes in consumer funding due to the repayment of installment payments, which may be used for consumer behavior modeling.

### SUMMARY

The present disclosure provides a description of systems and methods for the predicting of consumer behavior.

A method for predicting consumer behavior includes: storing, in a consumer database, a plurality of consumer profiles, wherein each consumer profile includes data related to one or more consumers including at least consumer data and a profile identifier; receiving, by a receiving device, an authorization request or clearing record for a payment transaction, wherein the authorization request or clearing record includes at least an indication of the payment transaction as an installment transaction, transaction data, a specific profile identifier, a repayment length, and an installment amount; identifying, in the consumer database, a specific consumer profile where the included profile identifier corresponds to the specific profile identifier; and transmitting, by a transmitting device, an indication of a propensity to have available funding based on the repayment length, wherein the indication includes at least the consumer data included in the identified specific consumer profile and the installment amount included in the received authorization request or clearing record.

A system for predicting consumer behavior includes a consumer database, a receiving device, a processing device, and a transmitting device. The consumer database is configured to store a plurality of consumer profiles, wherein each consumer profile includes data related to one or more consumers including at least consumer data and a profile identifier. The receiving device is configured to receive an authorization request or clearing record for a payment transaction, wherein the authorization request or clearing record includes at least an indication of the payment transaction as an installment transaction, transaction data, a specific profile identifier, a repayment length, and an installment amount. The processing device is configured to identify, in the consumer database, a specific consumer profile where the included profile identifier corresponds to the specific profile identifier. The transmitting device is configured to transmit an indication of a propensity to have available funding based on the repayment length, wherein the indication includes at least the consumer data included in the identified specific consumer profile and the installment amount included in the received authorization request or clearing record.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for predicting consumer behavior based on installment payments in accordance with exemplary embodiments.

FIG. 2 is a block diagram illustrating the processing server of FIG. 1 for the predicting of consumer behavior in accordance with exemplary embodiments.

FIG. 3 is a flow diagram illustrating a process for predicting consumer behavior based on installment payments using the system of FIG. 1 accordance with exemplary embodiments.

FIG. 4 is a flow diagram illustrating a process for predicting consumer behavior using the processing server of FIG. 2 in accordance with exemplary embodiments.

FIG. 5 is a flow chart illustrating an exemplary method for predicting consumer behavior in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

### System for Predicting Consumer Behavior

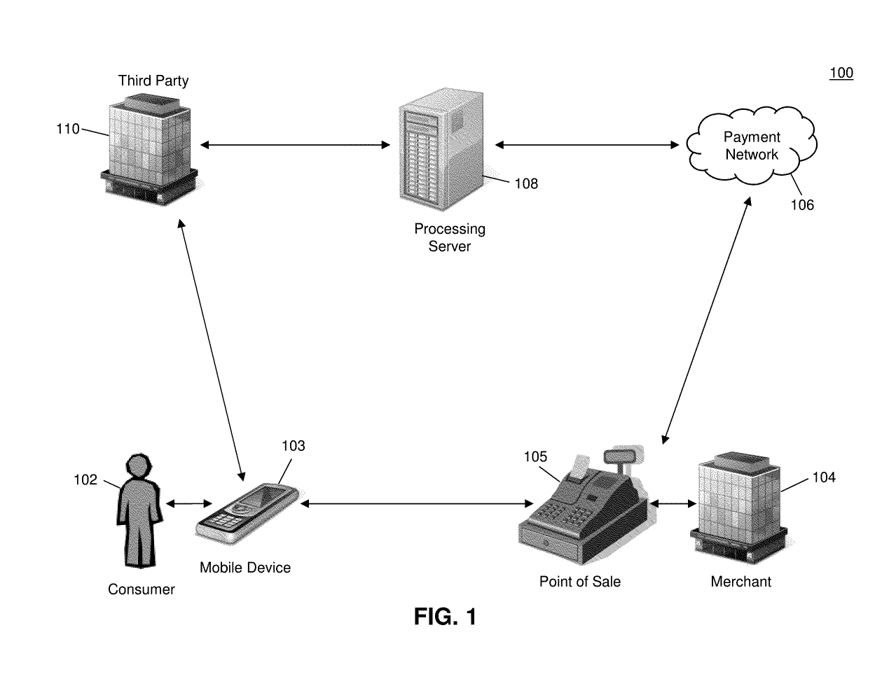

FIG. 1 illustrates a system 100 for the prediction of consumer behavior based on installment payments.

The system 100 may include a consumer 102. The consumer 102 may engage in a payment transaction with a merchant 104 for the purchase of goods or services. The consumer 102 may possess a payment card, which may be presented to the merchant 104 to fund the payment transaction. The payment transaction may be conducted in-person or remotely, such as via telephone, the Internet, etc. In some instances, the payment transaction may be conducted via a mobile device 103, such as a cellphone, smartphone, tablet computer, etc. In such an instance, the mobile device 103 may be used by the consumer 102 to identify payment details, which may be transmitted to the merchant 104 for use in funding the payment transaction.

The merchant 104 may receive the payment card and/or payment card details, which may include entry or reading of the payment details in or by a point of sale 105. The point of sale 105 may be configured to generate an authorization request for the payment transaction, with the authorization request including generated transaction data. The transaction data may indicate that the payment transaction is an installment transaction, where the consumer 102 may pay recurring payments to the merchant 104 over a specified period of time. As part of the payment transaction, the consumer 102 may also pay an initial amount to the merchant 104 at the time of processing of the payment transaction. The transaction data included in the generated authorization request may indicate initial payment to be made by the consumer 102 and may further indicate additional data regarding the installment, such as installment payment amounts, length of the installment, date of repayment, etc.

The installment transaction may be processed by a payment network 106. The point of sale 105 of the merchant 104 may transmit the generated authorization request to the payment network 106 for processing. The payment network 106 may include one or more computer systems that are configured to process installment transactions using methods and systems that will be apparent to persons having skill in the relevant art. The computing systems of the payment network 106 may process the transaction as an installment transaction based on the indication included in the authorization request for the transaction, such as by processing the initial payment amount and by recording the installment information in one or more databases for future recurring payments to be made from the consumer 102 to the merchant 104.

The system 100 may also include a processing server 108. The processing server 108, discussed in more detail below, may be a computing system configured to predict consumer behavior based on installment transactions. The processing server 108 may receive data comprising authorization requests or clearing records from the computing systems of the payment network 106 for installment transactions. In some embodiments, the processing server 108 may be a part of the payment network 106 and may receive the authorization requests or clearing records as part of the processing of the installment transactions by the payment network 106, such as from the computing devices configured to process the installment transactions.

The processing server 108 may, as discussed in more detail below, identify a consumer profile associated with the consumer 102 or the consumer's mobile device 103 and associated installment transactions. The processing server 108 may identify when the consumer 102 may have available funding based on repayment lengths and recurring payment amounts of installments to which the consumer 102 is associated. In some embodiments, the processing server 108 may associate the consumer 102 (e.g., the consumer profile associated with the consumer 102) with one or more consumer behavior models based on the associated installment transactions.

The processing server 108 may transmit data including the identified available funding and/or consumer behavior models to a computing device of a third party 110. The third party 110 may be an entity with one or more computing devices configured to analyze the received data and/or use the received information to provide services to the consumer 102. For example, in some instances, the third party 110 may be a credit bureau, which may use the information to identify (e.g., via calculation and analysis) changes in a credit score for the consumer 102 upon repayment of one or more installments. In another instance, the third party 110 may be a content provider, which may provide content (e.g., advertisements, offers, coupons, discounts, etc.) to the consumer 102 and/or the mobile device 103 associated with the consumer 102 based on a change in available funding for the consumer 102 upon final repayment of an installment.

In an exemplary embodiment, the processing server 108 may not provide the third party 110 with any personally identifiable information of the consumer 102. In such embodiments, the information provided to the third party 110 may be anonymized using methods and systems that will be apparent to persons having skill in the relevant art. For instance, in one embodiment, the consumer 102 may be included in a microsegment of other consumers, and the third party 110 may be provided with information regarding available funding or consumer behavior models for the microsegment of consumers. In some embodiments, the processing server 108 and/or third party 110 may receive express consent of the consumer 102.

By predicting consumer behavior of the consumer 102 based on installment payments, the processing server 108, or the third party 110 based on information provided by the processing server 108, may be able to provide valuable services to the consumer 102 and may be able to perform valuable analysis regarding the consumer 102 and other consumers. In addition, as the recurring payments for installment transactions may be known ahead of time, the processing server 108 may be able to perform the functions discussed herein prior to repayment of installments by the consumer 102, and thus be able to provide benefits to the consumer 102 in anticipation of repayment of the installments.

### Processing Server

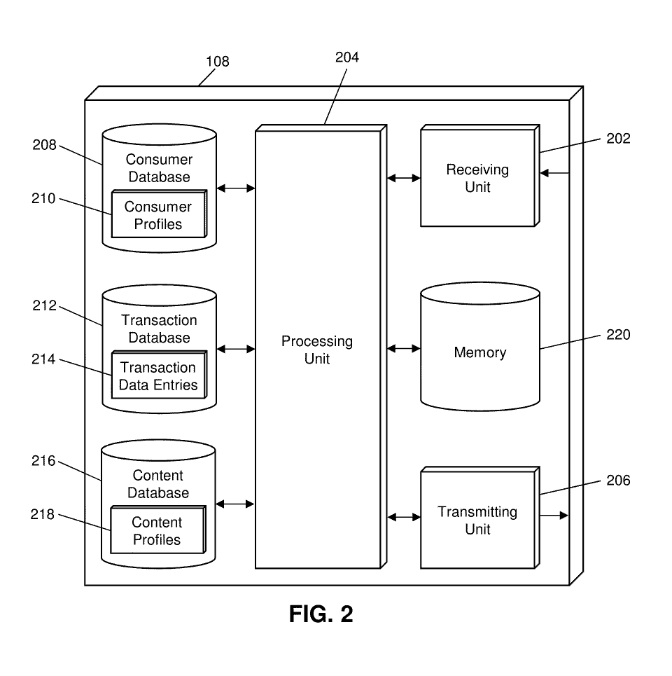

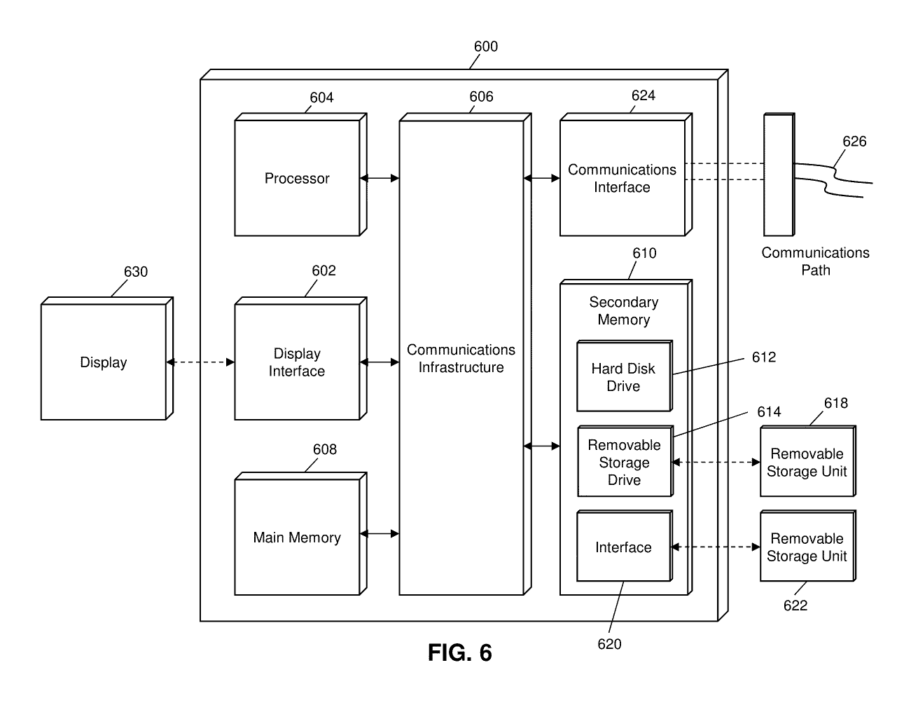

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of processing server 108 suitable for performing the functions as discussed herein. For example, the computer system 600 illustrated in FIG. 6 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive authorization requests or clearing records from the systems of the payment network 106. The authorization requests or clearing records may comprise data associated with an installment transaction and may include at least an indication that the associated transaction is an installment transaction, a profile identifier, a repayment length, and an installment amount. The indication may be in a data element included in the authorization request or clearing record, or other suitable method for indicating the transaction as being an installment transaction.

The repayment length may be a time and/or date at which the installment will be repaid, a number of installment payments to be paid, a number of remaining installments, and/or any other suitable value corresponding to the installment that may be used to identify a time and/or date at which the installment will be repaid. The installment amount may be the amount of each installment payment to be paid from the consumer 102 to the merchant 104. The profile identifier may be a unique value associated with a consumer profile 210 that corresponds to the consumer 102, such as an identification number, a payment account number, or other suitable value.

The consumer profile 210 may be one of a plurality of consumer profiles 210 stored in a consumer database 208 of the processing server 108. Each consumer profile 210 may be configured to store data related to a consumer 102 including at least a profile identifier and consumer data. The consumer data may include contact information, consumer preferences, demographic data, purchase behavior, credit data, and/or any other suitable data associated with the consumer 102 that may be beneficial for the processing server 108 and/or systems of a third party 110 to use, such as for providing content to the consumer 102. In an exemplary embodiment, the consumer data may not include any personally identifiable information. In some embodiments, the consumer data may indicate that the associated consumer 102 is part of a microsegment of consumers. In other embodiments, the consumer profile 210 may be associated with a microsegment of consumers, and the consumer data may include data associated with the microsegment of consumers.

The processing server 108 may also include a processing unit 204. The processing unit 204 may be configured to perform the functions disclosed herein as will be apparent to persons having skill in the relevant art. The processing unit 204 may identify the specific consumer profile 210 in the consumer database 208 associated with the consumer 102 based on the profile identifier included in the received authorization request or clearing record. The processing unit 204 may also be configured to identify a propensity of the associated consumer 102 to have available funding based on the repayment length included in the received authorization request or clearing record.

The processing server 108 may further include a transmitting unit 206. The transmitting unit 206 may be configured to transmit data over one or more networks via one or more network protocols. The transmitting unit 206 may transmit an indication of the propensity to have available funding to a third party 110 via a data transmission to one or more computing systems of the third party 110. The indication may include the propensity of the consumer 102 to have available funding and may further include at least the consumer data included in the corresponding consumer profile 210 and the installment amount included in the received authorization request or clearing record.

The processing server 108 may also include a memory 220. The memory 220 may be configured to store data for use in performing the functions disclosed herein. For instance, in one embodiment, the memory 220 may store program code for one or more application programs to be executed by the processing unit 204 for performing the functions disclosed herein, such as for identifying a propensity for a consumer 102 to have available funding and the generation and transmission thereof of an indication of the propensity to have available funding.

In some embodiments, the processing server 108 may also include a transaction database 212. The transaction database 212 may be configured to store one or more transaction data entries 214. In one embodiment, each transaction data entry 214 may include data related to an installment transaction, such as the received authorization request or clearing record associated with the installment transaction. The transaction data entries 214 may be stored in the transaction database 212 for monitoring of the corresponding installment transactions to ensure repayment and/or for later identification of an associated consumer's propensity for available funding based on estimated repayment.

In another embodiment, each transaction data entry 214 may include transaction data related to a payment transaction for one or more merchants 104. The processing unit 204 may be configured to identify installment transactions based on the transaction data included in the transaction data entries 214. For example, each transaction data entry 214 may include a transaction amount, a transaction time and/or date, and a profile identifier corresponding to an associated consumer 102. The processing unit 204 may identify a pattern of recurring payments based on the transaction data that may indicate an installment transaction involving the consumer 102. Based on history of other transaction data entries 214, the processing unit 204 may identify an estimated date of repayment for the installment transaction, such as based on a total number of installment payments made for the same amount to the same merchant 104 by other consumers 102. The processing unit 204 may then identify a propensity for the consumer 102 to have available funding as described above.

In some embodiments, the processing server 108 may also include a content database 216. The content database 216 may be configured to store one or more content profiles 218. Each content profile 218 may include data related to content to be provided including at least selection criteria and a content item. The processing unit 204 may be configured to identify a content profile 218 for a consumer 102 based on the included selection criteria and the consumer data stored in the consumer profile 210 associated with the consumer 102 and the identified propensity to have available funding for the consumer 102. The transmitting unit 206 may be configured to transmit the content item included in the identified content profile 218 to the consumer 102 or to the mobile device 103 associated with the consumer 102. For example, electronic content may be transmitted to the mobile device 103, while physical content (e.g., mailed coupons or offers) may be delivered to the consumer 102 via traditional methods. The content item may comprise an advertisement, offer, service, deal, discount, or other suitable type of content as will be apparent to persons having skill in the relevant art.

### Process for Predicting Consumer Behavior Based on Installments

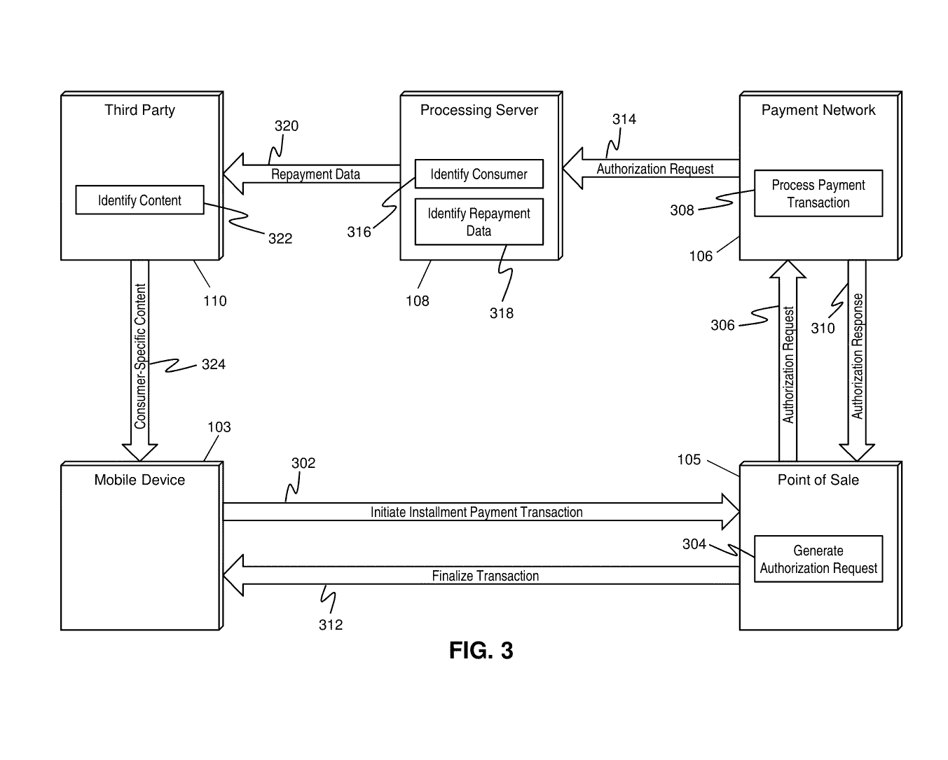

FIG. 3 illustrates a process for the predicting of consumer behavior based on installments using the system 100.

In step 302, the consumer 102 may initiate an installment payment transaction with the merchant 104 for the purchase of goods or services via recurring installment payments using their mobile device 103. The transaction may be an in-person transaction or a remotely conducted transaction, such as an Internet transaction, conducted via the mobile device 103 and the point of sale 105 or other suitable computing system of the merchant 104. Initiation of the transaction may include the transmission of payment details from the mobile device 103 to the point of sale 105 using methods and systems that will be apparent to persons having skill in the relevant art.

In step 304, the point of sale 105 of the merchant 104 (e.g., or of an acquirer associated with the merchant 104) may generate an authorization request for the installment transaction. In step 306, the point of sale 105 may transmit data comprising the generated authorization request to a computing system of the payment network 106.

In step 308, the systems of the payment network 106 may process the installment transaction using methods and systems that will be apparent to persons having skill in the relevant art. As part of the processing of the transaction, in step 310 an authorization response may be transmitted by the payment network's computing systems from the payment network 106 to the point of sale 105 of the merchant 104 indicating approval of the installment transaction. In step 312, the merchant 104 may finalize the transaction with the consumer 102, such as by displaying a transaction approval message on the point of sale 105 and furnishing the transacted-for goods or services to the consumer 102.

In step 314, the systems of the payment network 106 may forward data comprising the authorization request for the installment transaction, or a clearing record associated with the installment transaction, to the processing server 108. The processing server 108 may receive (e.g., via the receiving unit 202) the authorization request or clearing record, and may, in step 316, identify a consumer profile 210 in the consumer database 208 associated with the consumer 102 based on an included profile identifier corresponding to a profile identifier included in the received authorization request or clearing record.

In step 318, the processing server 108 may identify repayment data for repayment of the installment transaction based on data included in the received authorization request or clearing record. Identification of repayment data may include identification of a propensity to have available funding based on the repayment length of the installment, which may include at least consumer data included in the consumer profile 210 and the installment amount included in the received authorization request or clearing record. In step 320, the repayment data may be transmitted (e.g., via the transmitting unit 206) to a system of the third party 110.

In step 322, the computing system of the third party 110 may identify content for distribution to the consumer 102 based on the received consumer data and installment amount, which may indicate the amount of money that the consumer 102 may have available and may include information suitable for the identification of the content. In step 324, the third party 110 may transmit the consumer-specific content to the mobile device 103 consumer 102. The consumer-specific content may be transmitted to the mobile device 103 via methods that will be apparent to persons having skill in the relevant art, such as e-mail, short message service message, multimedia message service message, telephone, an application program, etc.

### Prediction of Consumer Behavior for Content Identification

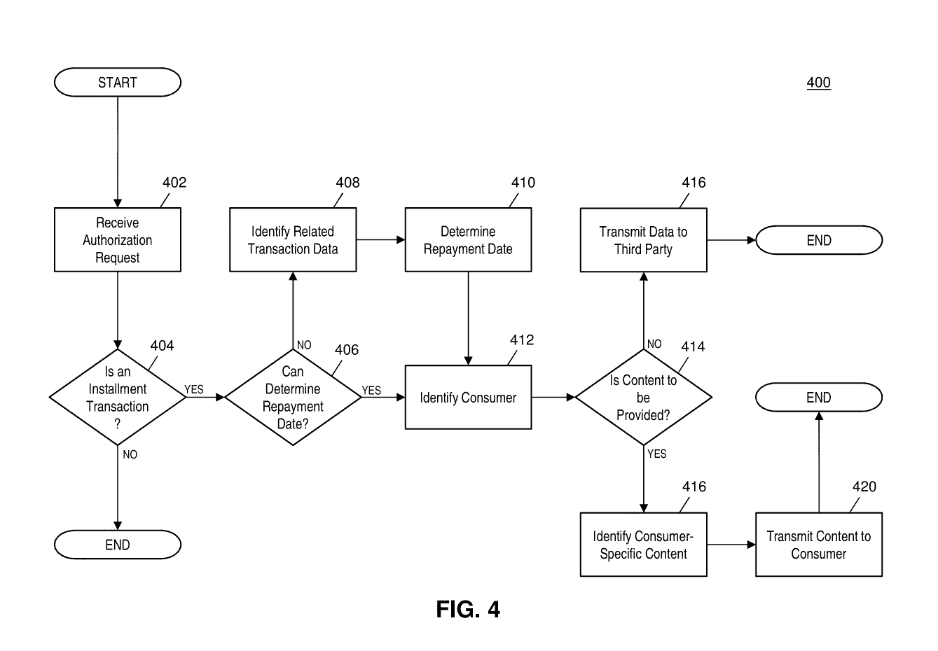

FIG. 4 illustrates a process 400 for the prediction of consumer behavior based on installment transactions for the identification of consumer-specific content using the processing server 108.

In step 402, the receiving unit 202 of the processing server 108 may receive an authorization request or clearing record for a payment transaction. The authorization request or clearing record may include a transaction amount, a transaction time and/or date, and a profile identifier. In some instances, the authorization request or clearing record may also include an indication that the payment transaction is an installment transaction, and may also include a repayment length and installment amount. In one instance, the installment amount and the transaction amount may be the same value.

In step 404, the processing unit 204 may determine if the payment transaction is an installment transaction. The determination may be based on whether or not the authorization request or clearing record includes the indication of the payment transaction being an installment transaction. If the payment transaction is not an installment transaction, then the process 400 may be completed. In some embodiments, the processing unit 204 may generate a transaction data entry 214 for the payment transaction to be stored in the transaction database 212, such as for use in identifying future installment transactions.

If the payment transaction is determined to be an installment transaction, then, in step 406, the processing unit 204 may identify if the repayment date for the transaction can be determined, such as via a data element included in the authorization request or clearing record indicating the repayment data. If the repayment date cannot be determined via the authorization request or clearing record, then, in step 408, the processing unit 204 may identify related transaction data via transaction data entries 214 in the transaction database 212. Related transaction data may include transaction data in transaction data entries 214 that involve the same merchant or have other commonality to the received authorization request or clearing record, which may be used to identify a repayment date.

In step 410, the processing unit 204 may determine the repayment date from the identified transaction data. For example, the processing unit 204 may identify similar recurring transactions involving the same merchant 104 for the same installment amount, and may determine a length of time after which the recurring payments end. Additional methods for determining a repayment date from transaction data will be apparent to persons having skill in the relevant art.

Once the repayment date has been identified, then, in step 412, the processing unit 204 may identify the consumer 102 via identification of a consumer profile 210 in the consumer database 208 associated with the consumer 102. The consumer profile 210 may be identified via correspondence between an included profile identifier and a profile identifier included in the received authorization request clearing record. In some embodiments, the profile identifier may be a payment account number or other value that may be included in an authorization request or clearing record.

In step 414, the processing unit 204 may determine if content is to be provided to the consumer 102. If content is to be provided to the consumer 102 or the consumer's mobile device 103 by the processing server 108, then, in step 416, the processing unit 204 may identify consumer-specific content via a content profile 218 in the content database 216. Identifying consumer-specific content may include identifying a content profile 218 based on correspondence between selection criteria included in the content profile 218 and the consumer data included in the identified consumer profile 210. In step 418, a content item or items included in the identified content profile 218 may be transmitted to the consumer 102 (e.g., to the mobile device 103 associated with the consumer 102) by the transmitting unit 206. If no content is to be provided to the consumer 102, then, in step 420, the transmitting unit 206 may transmit the consumer data and other repayment data to the third party 110.

### Exemplary Method for Predicting Consumer Behavior

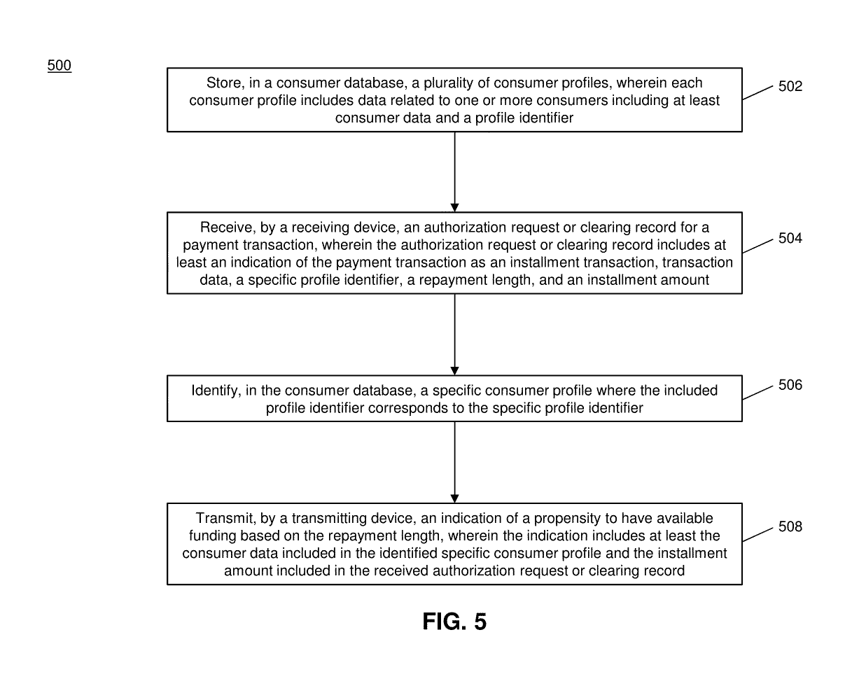

FIG. 5 illustrates a method 500 for predicting consumer behavior based on installment transactions.

In step 502, a plurality of consumer profiles (e.g., consumer profiles 210) may be stored in a consumer database (e.g., the consumer database 208), wherein each consumer profile 210 includes data related to one or more consumers (e.g., consumers 102) including at least consumer data and a profile identifier. In one embodiment, each consumer profile 210 may be related to a microsegment of consumers. In some embodiments, the consumer data does not include personally identifiable information. In one embodiment, the consumer data may include at least one of: demographic data, purchase behavior, and credit data.

In step 504, an authorization request or clearing record for a payment transaction may be received by a receiving device (e.g., the receiving unit 202), wherein the authorization request or clearing record includes at least an indication of the payment transaction as an installment transaction, transaction data, a specific profile identifier, a repayment length, and an installment amount. In one embodiment, the repayment length may be at least one of: a number of installments, a date, and a period of time. In step 506, a specific consumer profile 210 may be identified, in the consumer database 208, where the included profile identifier corresponds to the specific profile identifier.

In step 508, an indication of a propensity to have available funding based on the repayment length may be transmitted by a transmitting device (e.g., the transmitting unit 206), where the indication includes at least the consumer data included in the identified specific consumer profile 210 and the installment amount included in the received authorization request or clearing record. In one embodiment, the indication may further include one of: the repayment length or a time and/or date of an end of the repayment length. In some embodiments, the indication may be transmitted at an end of the repayment length or during repayment.

In one embodiment, the profile identifier may be a unique identification value, and the specific profile identifier may be a specific payment account number. In a further embodiment, the method 500 may further include identifying, by a processing device (e.g., the processing unit 204), a profile identification value associated with a plurality of payment account numbers including the specific payment account number, wherein the identified profile identification value is the unique identification value. In another embodiment, the method 500 may further include identifying, by the processing device 204, a credit risk for the one or more consumers related to the identified specific consumer profile 210 based on at least the included consumer data, the installment amount, and the repayment length.

In some embodiments, the method 500 may further include: storing, in a content database (e.g., the content database 216), one or more content profiles (e.g., content profiles 218), wherein each content profile 218 includes at least selection criteria and a content item; identifying, in the content database 216, a specific content profile 218 based on the included selection criteria and at least the consumer data included in the identified specific consumer profile 210 and the installment amount; and transmitting, by the transmitting device 206, at least the content item included in the identified specific content profile 218 to the one or more consumers 102 related with the identified specific consumer profile 210.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for consumer behavior. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for predicting consumer behavior, comprising:
storing, in a consumer database, a plurality of consumer profiles, wherein each consumer profile includes data related to one or more consumers including at least consumer data and a profile identifier;
receiving, by a receiving device, an authorization request or clearing record for a payment transaction, wherein the authorization request or clearing record includes at least an indication of the payment transaction as an installment transaction, transaction data, a specific profile identifier, a repayment length, and an installment amount;
identifying, in the consumer database, a specific consumer profile where the included profile identifier corresponds to the specific profile identifier; and
transmitting, by a transmitting device, an indication of a propensity to have available funding based on the repayment length, wherein the indication includes at least the consumer data included in the identified specific consumer profile and the installment amount included in the received authorization request or clearing record.

2. The method of claim 1, wherein the indication of a propensity to have available funding further includes one of: the repayment length or a time and/or date of an end of the repayment length.

3. The method of claim 1, wherein the indication of a propensity to have available funding is transmitted at an end of the repayment length or during repayment.

4. The method of claim 1, wherein the repayment length is at least one of: a number of installments, a date, and a period of time.

5. The method of claim 1, wherein each consumer profile is related to a microsegment of consumers.

6. The method of claim 1, wherein
the profile identifier is a unique identification value,
the specific profile identifier is a specific payment account number, and
the method further comprises:
identifying, by a processing device, a profile identification value associated with a plurality of payment account numbers including the specific payment account number, wherein the identified profile identification value is the unique identification value.

7. The method of claim 1, wherein the consumer data does not include personally identifiable information.

8. The method of claim 1, wherein the consumer data includes at least one of: demographic data, purchase behavior, and credit data.

9. The method of claim 1, further comprising:
identifying, by a processing device, a credit risk for the one or more consumers related to the identified specific consumer profile based on at least the included consumer data, the installment amount, and the repayment length.

10. The method of claim 1, further comprising:
storing, in a content database, one or more content profiles, wherein each content profile includes at least selection criteria and a content item;
identifying, in the content database, a specific content profile based on the included selection criteria and at least the consumer data included in the identified specific consumer profile and the installment amount; and
transmitting, by the transmitting device, at least the content item included in the identified specific content profile to the one or more consumers related with the identified specific consumer profile.

11. A system for predicting consumer behavior, comprising:
a consumer database configured to store a plurality of consumer profiles, wherein each consumer profile includes data related to one or more consumers including at least consumer data and a profile identifier;
a receiving device configured to receive an authorization request or clearing record for a payment transaction, wherein the authorization request or clearing record includes at least an indication of the payment transaction as an installment transaction, transaction data, a specific profile identifier, a repayment length, and an installment amount;
a processing device configured to identify, in the consumer database, a specific consumer profile where the included profile identifier corresponds to the specific profile identifier; and
a transmitting device configured to transmit an indication of a propensity to have available funding based on the repayment length, wherein the indication includes at least the consumer data included in the identified specific consumer profile and the installment amount included in the received authorization request or clearing record.

12. The system of claim 11, wherein the indication of a propensity to have available funding further includes one of: the repayment length or a time and/or date of an end of the repayment length.

13. The system of claim 11, wherein the indication of a propensity to have available funding is transmitted at an end of the repayment length or during repayment.

14. The system of claim 11, wherein the repayment length is at least one of:
a number of installments, a date, and a period of time.

15. The system of claim 11, wherein each consumer profile is related to a microsegment of consumers.

16. The system of claim 11, wherein
the profile identifier is a unique identification value,
the specific profile identifier is a specific payment account number, and
the processing device is further configured to identify a profile identification value associated with a plurality of payment account numbers including the specific payment account number, wherein the identified profile identification value is the unique identification value.

17. The system of claim 11, wherein the consumer data does not include personally identifiable information.

18. The system of claim 11, wherein the consumer data includes at least one of: demographic data, purchase behavior, and credit data.

19. The system of claim 11, wherein the processing device is further configured to identify a credit risk for the one or more consumers related to the identified specific consumer profile based on at least the included consumer data, the installment amount, and the repayment length.

20. The system of claim 11, further comprising:
a content database configured to store one or more content profiles, wherein each content profile includes at least selection criteria and a content item, wherein
the processing device is further configured to identify, in the content database, a specific content profile based on the included selection criteria and at least the consumer data included in the identified specific consumer profile and the installment amount, and
the transmitting device is further configured to transmit at least the content item included in the identified specific content profile to the one or more consumers related with the identified specific consumer profile.
